(19) United States
(12) Patent Application Publication
(10) Pub. No.: US 2017/0297383 A1
(43) Pub. Date: Oct. 19, 2017

(54) RUN-FLAT TIRE

(71) Applicant: BRIDGESTONE CORPORATION, Tokyo (JP)

(72) Inventors: Shintaro HATANAKA, Tokyo (JP); Isao KUWAYAMA, Tokyo (JP)

(73) Assignee: BRIDGESTONE CORPORATION, Tokyo (JP)

(21) Appl. No.: 15/512,744

(22) PCT Filed: Aug. 21, 2015
(86) PCT No.: PCT/JP2015/004209

§ 371 Date: Mar. 20, 2017

(30) Foreign Application Priority Data
Oct. 3, 2014 (JP) 2014-205250

(51) Int. Cl. B60C 17/00; B60C 3/04; B60C 11/03

(52) U.S. Cl. CPC B60C 17/0009; B60C 3/04; B60C 2017/0072; B60C 2011/0353

(57) ABSTRACT

The run-flat tire of this disclosure includes a tread portion, a pair of sidewall portions, bead portions, side reinforcing rubbers with crescent-like cross section, and a carcass formed of plies of radially arranged cords, wherein: when the tire is mounted to a rim, and an internal pressure of 250 kPa or more is applied to the tire, in a case where a sectional width SW of the tire is less than 165 mm, a ratio of the sectional width SW to an outer diameter OD of the tire, SW/OD, is 0.26 or less; in a case where the sectional width SW of the tire is 165 mm or more, the sectional width SW and the outer diameter OD of the tire satisfy a relation expression OD≧2.135×SW+282.3 (mm); and the relation expression 0.5≦WG/WB≦0.8 is satisfied.

### TECHNICAL FIELD

This disclosure relates to a run-flat tire.

### BACKGROUND

Conventionally, as disclosed in PTL1, suggested is a technique for improving fuel efficiency by using a narrow-width, large-diameter tire, which is desired as an effective technique for use as, e.g., a tire for electric automobiles.

### CITATION LIST

### Patent Literature

PTL1: WO2012/176476A1

### SUMMARY

### Technical Problem

In the aforementioned technique, run-flat travelling performances are desired as well. However, as for a run-flat tire having on a sidewall portion a side reinforcing rubber with a crescent-like cross section, considering that high fuel efficiency is deteriorated due to weight increase caused by the side reinforcing rubber, it is desired that the aforementioned narrow-width, large-diameter tire achieves both high fuel efficiency and run-flat durability.

This disclosure is to provide a run-flat tire which improves the fuel efficiency, and simultaneously ensures the run-flat durability.

### Solution to Problem

The subject of this disclosure is as follows.

The run-flat tire of this disclosure includes a tread portion, a pair of sidewall portions continuous on both sides of the tread portion, bead portions continuous on each sidewall portion, side reinforcing rubbers with crescent-like cross section disposed on the sidewall portions, and a carcass formed of plies of radially arranged cords extending toroidally between the pair of bead portions, wherein: when the tire is mounted to a rim, and an internal pressure of 250 kPa or more is applied to the tire, in a case where a sectional width SW of the tire is less than 165 mm, a ratio of the sectional width SW to an outer diameter OD of the tire, SW/OD, is 0.26 or less; and in a case where the sectional width SW of the tire is 165 mm or more, the sectional width SW and the outer diameter OD of the tire satisfy a relation expression OD≧2.135×SW+282.3 (mm); a tire radial outer side of the carcass further includes a belt formed of one or more belt layers; the tread portion has one or more circumferential grooves continuously extending in a tire circumferential direction; and the relation expression of 0.5≦WG/WB≦0.8 is satisfied, where WB represents a half width in the tire width direction of a belt layer maximum in width in the tire width direction of the one or more belt layers in a tire widthwise cross section in a reference state where the tire is mounted to a rim and filled with a predetermined internal pressure with no load applied thereon, and WG represents a tire widthwise distance from a tire widthwise end of the belt layer maximum in width in the tire width direction to a tire widthwise center position of a circumferential groove in the tire widthwise outermost side of the one or more circumferential grooves.

Here, the “rim” is a valid industrial standard for the region in which the tire is produced or used, and refers to a standard rim of an applicable size (the “Measuring Rim” in the STANDARDS MANUAL of ETRTO, and the “Design Rim” in the “YEAR BOOK” of TRA) which is described or will be described in the “JATMA Year Book” of JATMA (The Japan Automobile Tyre Manufacturers Association) in Japan, the “ETRTO STANDARD MANUAL” of ETRTO (the European Tyre and Rim Technical Organisation) in Europe, or the “TRA YEAR BOOK” of TRA (the Tire and Rim Association, Inc.) in the United States of America, etc. (namely, the aforementioned “rim” is inclusive of current sizes and sizes which are possibly included in the aforementioned industrial standards. Examples for “size which will be described” are the sizes described as “FUTURE DEVELOPMENTS” in ETRTO 2013 edition.). As for sizes not described in the aforementioned industrial standards, the “rim” refers to rims having a width corresponding to the bead width of the tire.

Moreover, the “predetermined internal pressure” refers to a state that the tire is applied an air pressure of a single wheel corresponding to a maximum load capability (maximum air pressure) at applicable size and ply rating, as described by JATMA, etc. As for sizes not described in the aforementioned industrial standards, the “predetermined internal pressure” refers to an air pressure corresponding to a maximum load capability determined depending on the vehicle to which the tire is mounted (maximum air pressure). Further, the “maximum load” mentioned below refers to a load corresponding to the aforementioned maximum load capability.

The description “continuously extending in a tire circumferential direction” is inclusive of the case of extending in a straight line shape continuously in the tire circumferential direction, the case of extending in a zigzag shape, and the case of extending in a bended shape.

Further, “the tire widthwise center position of the circumferential groove” refers to the tire widthwise position of the midpoint of a segment connecting the circumferential groove and the tread surface on the tire widthwise cross section.

In the case where one or both of the “tire radial outermost point of the bead filler” and the “tire radial outermost point of the bead core” mentioned below exist in a plurality, a segment is connected in a manner such that H2 is maximum.

The “maximum thickness measured in a direction perpendicular to the carcass” mentioned below refers to, in the case where the carcass has a folded-up structure formed of a carcass main body and a carcass folded-up portion, a maximum thickness measured in a direction perpendicular to the carcass main body.

### Advantageous Effect

According to this disclosure, it is possible to provide a run-flat tire which improves the fuel efficiency, and simultaneously ensures the run-flat durability.

### BRIEF DESCRIPTION OF THE DRAWINGS

FIG. 1 illustrates a tire widthwise cross-sectional view of a run-flat tire according to one embodiment of this disclosure;

FIG. 2 illustrates a developed view showing a tread pattern of a run-flat tire according to one embodiment of this disclosure;

FIG. 3 illustrates a developed view showing a tread pattern of a run-flat tire according to another embodiment of this disclosure;

FIG. 4 illustrates a tire widthwise partial cross-sectional view of a run-flat tire according to one embodiment of this disclosure; and

FIG. 5(a)(b) illustrates a contact state in run-flat traveling.

### DETAILED DESCRIPTION

Hereinafter, an embodiment of this disclosure will be described with reference to the drawings.

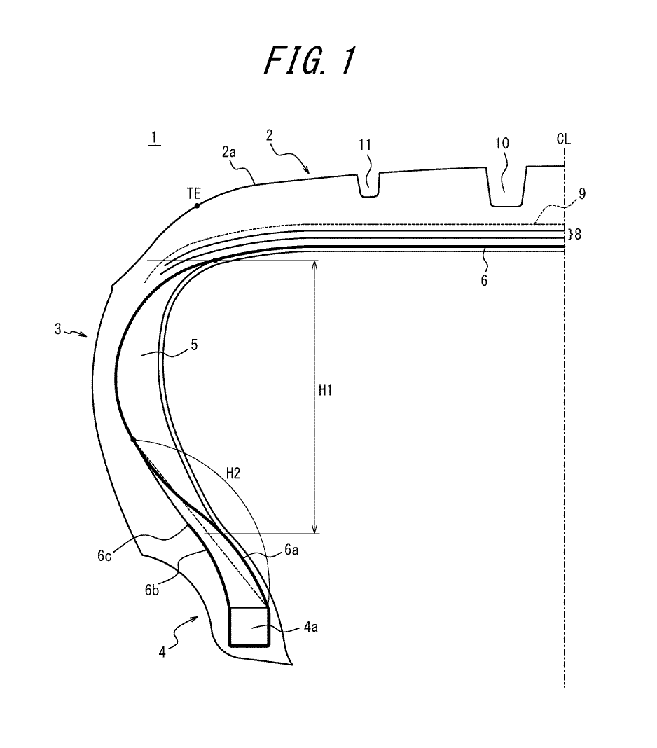

FIG. 1 illustrates a tire widthwise cross-sectional view of a run-flat tire (hereinafter referred to as merely “tire”) according to one embodiment of this disclosure. Illustrated in FIG. 1 is a tire widthwise cross section of the tire in a reference state as being mounted to a rim and filled with a predetermined internal pressure with no load applied thereon.

Here, when this tire 1 is mounted to a rim, and an internal pressure of 250 kPa or more is applied to the tire 1, in a case where a sectional width SW of the tire is less than 165 mm, a ratio of the sectional width SW (mm) to an outer diameter OD (mm) of the tire 1, SW/OD, is 0.26 or less; and in a case where the sectional width SW of the tire is 165 mm or more, the sectional width SW (mm) and the outer diameter OD (mm) of the tire 1 satisfy a relation expression OD≧2.135×SW+282.3 (mm).

The run-flat tire of this disclosure is not limited, and may be exemplified as those of tire size 145/60R19, 145/60R18, 145/60R17, 155/70R19, 155/55R19, 155/55R18, 165/60R19, 165/55R18, 175/60R19, 175/55R18, 175/55R20, 175/60R18, 185/60R20, 185/55R20, 185/60R19, 185/55R19, 195/50R20, 195/55R20, 205/50R21, etc.

As illustrated in FIG. 1, the tire 1 includes a tread portion 2, a pair of (one illustrated) sidewall portions 3 continuous on both sides (one side illustrated) of the tread portion 2, bead portions 4 continuous on each (one illustrated) sidewall portion 3, side reinforcing rubbers 5 with crescent-like cross section disposed on the sidewall portions 3, a carcass 6 formed of plies of radially arranged cords extending toroidally between the pair of (one illustrated) bead portions 4.

As illustrated in FIG. 1, the bead portions 4 have bead cores 4a. In this disclosure, the bead cores 4a may have various shapes such as circular cross section, polygonal cross section, etc.

Moreover, in the present embodiment, on tire radial outer sides of the bead cores 4a, bead fillers 7 with an approximately triangular cross section are arranged. On the other hand, this disclosure may have a structure without bead fillers 7.

Further, the bead portions 4 may have reinforcement members such as reinforcing rubber layers, reinforcing cord layers and the like disposed thereon. These reinforcement members may be disposed on various positions on the bead portions 4; for example, the reinforcement members may be disposed on tire widthwise outer sides and/or inner sides of the bead fillers 7.

In the present embodiment, the carcass 6 has a carcass main body 6a and a carcass folded-up portion 6b, the carcass main body 6a fixed to the pair of bead cores 4a, the carcass folded-up portion 6b extending from the carcass main body 6a and formed by folding up a circumference of the bead cores 4a from a tire widthwise inner side to a tire widthwise outer side.

On the other hand, in this disclosure, the carcass 6 is not limited to folded-up structure, but may be, for example, a structure such that the bead cores 4a are separated into a plurality, and the carcass 6 is surrounded by the plurality of separated bead core members.

In this disclosure, the carcass line may be of various shapes, for example, a carcass maximum width position may be set either close to the bead portions 4 side or close to the tread portion 2 side.

The number of cords of the carcass may be in a range of 20 to 60 per 50 mm, without being limited thereto.

In the present embodiment, a folded-up end 6c of the folded-up portion 6b of the carcass 6 is located on a tire radial side inner than a tire radial outer end of the bead filler 7, while it is possible to locate the same on a tire radial outer end of the bead filler 7 or a tire radial side outer than a tire maximum width position.

Moreover, in the case where the carcass 6 is formed of a plurality of carcass plies, the positions of the folded-up ends 6c of each ply may be different from each other.

In the present embodiment, the carcass 6 extends continuously between the bead cores 4a completely, while in this disclosure, the carcass 6 is not limited to the aforementioned example, and may, for example, extend from the bead core 4a to a tire widthwise outer region of the tread portion 2, to form a pair of divided carcasses of which a tire widthwise central region is extracted.

Here, as illustrated in FIG. 1, this tire 1 further has a belt 8 formed of belt layers (two in the illustrated example) on a tire radial outer side of a crown portion of the carcass 6, and reinforcing belt layers 9 (one in the illustrated example) arranged on a tire radial outer side of the belt 8.

Here, in the illustrated example, the belt 8 is an inclined belt, in which belt cords cross each other between the layers. The belt cords may be, for example, steel cords, organic fiber cords, etc., without being limited thereto. Moreover, the belt cords of each belt layer may extend at an angle of 20 to 75° with respect to the tire circumferential direction.

Moreover, the belt reinforcement layers 9 may use spiral cords coiling in a spiral shape approximately in the tire circumferential direction, high rigidity cords (cords having a Young's modulus of 50 MPa or more determined according to JIS L1017 8.8 (2002) when tested according to JIS L1017 8.5 a) (2002)), low rigidity cords (cords having a Young's modulus of less than 50 MPa at the same conditions), high elongation cords, high heat shrinkage cords (cords having a heat shrinkage of 1% or more with a load of 50 g under 170° C.), etc. Further, the cords of the belt reinforcement layers 9 may be monofilament cords, cords obtained by twisting a plurality of filaments, or even cords obtained by twisting filaments of different materials. In the illustrated example, the tire widthwise width of the belt layer on the tire radial inner side is longer than the tire widthwise width of the belt layer on the tire radial outer side, while the tire widthwise width of the belt layer on the tire radial inner side may be shorter than the tire widthwise width of the belt layer on the tire radial outer side as well.

The number of cords of the belt reinforcement layers 9 may be in a range of 20 to 60 per 50 mm, without being limited thereto.

Moreover, the cords of the belt reinforcement layers 9 may be distributed with the rigidity, the material, the number of layers, the number of cords, etc. varying in the tire width direction. For example, the number of layers may be increased in merely the tire widthwise end, or in merely the tire widthwise central portion.

Moreover, the tire widthwise width of the belt reinforcement layers 9 may be either larger or smaller than the belt 8.

Further, in the present embodiment, the belt reinforcement layers 9 are arranged on the tire radial outer side of the belt 8, while in this disclosure, the belt reinforcement layers 9 may be arranged on the tire radial inner side of the belt 8 as well.

Moreover, a belt layer having a largest tire widthwise width among one or more belt layers preferably has a tire widthwise width of 90% to 120%, more preferably 100% to 110%, of a tread width. Here, the “tread width” refers to a tire widthwise width of the contact patch which contacts the road surface when filled with the aforementioned predetermined internal pressure with the aforementioned maximum load applied thereon.

Here, in this disclosure, the tread portion 2 may be formed of one rubber layer, or formed by laminating in the tire radial direction a plurality of different rubber layers. In the case of using a plurality of different rubber layers, loss tangent, modulus, hardness, glass-transition temperature, material, etc. thereof may be different. Moreover, the thickness of the plurality of rubber layers may vary in the tread width direction, and merely groove bottoms of circumferential grooves may be formed of rubber layers of types different from its surroundings.

Moreover, in this disclosure, the tread portion 2 may be formed by arranging a plurality of different rubber layers in the tire width direction, and in this case, loss tangent, modulus, hardness, glass-transition temperature, material, etc. may vary among the layers. Moreover, it is possible to vary the ratio of tire widthwise width of the plurality of rubber layers in the tread radial direction, or to use rubber layers of types different from its surroundings in merely a part of the region, such as merely groove bottoms of circumferential grooves, merely the vicinity of tread edges, merely tire widthwise outermost land portions, merely a tire widthwise central land portion, etc. Here, the “tread edge” refers to a tire widthwise outermost end of a portion contacting with the road surface when filled with the aforementioned predetermined internal pressure with the maximum load applied thereon.

In this disclosure, in a tire widthwise cross section in the aforementioned reference state, a ratio LCR/TW is preferably 0.06 or less and more preferably 0.02 or more and 0.05 or less, where LCR is a height difference, i.e., a tire radial distance between a straight line m1 and a straight line m2, m1 is a straight line parallel to the tire width direction across a point on the tread surface in the tire equatorial plain CL (a point on a virtual outer contour line of the tread in the case where the portion is a groove), m2 is a straight line parallel to the tire width direction across the tread edge TE, and TW is a tread width. This is because that the durability and the wear resistance of the tire can be improved.

Further, in this disclosure, the thickness of the sidewall portions 3 is preferably thin. Specifically, in the aforementioned reference state, a tire widthwise cross section area S1 of the bead fillers 7 is preferably 1 to 4 times to a tire widthwise area S2 of the bead cores 4a. By setting S1 to 4 times or less to S2, the riding comfort can be ensured, while on the other hand, by setting S1 to one time or more to S2, the steering stability can be ensured.

In the tire of this disclosure, the loss tangent tan δ of the side reinforcing rubbers 5 is preferably 0.05 to 0.15. By setting the loss tangent tan δ to 0.05 or more, the damping property can be improved, while on the other hand, by setting the loss tangent tan δ to 0.15 or less, the heat buildup in the side reinforcing rubbers 5 can be suppressed. Further, in the tire of this disclosure, the 50% stretch modulus of the side reinforcing rubbers 5 is preferably 1.5 to 6.0 MPa. By setting the 50% stretch modulus of the side reinforcing rubbers 5 to 1.5 MPa or more, the steering stability can be further ensured, while on the other hand, by setting the 50% stretch modulus of the side reinforcing rubbers 5 to 6.0 MPa or less, the comfort and riding comfort can be further ensure. Further, the aforementioned loss tangent tan δ and 50% stretch modulus refer to values measured with respect to a specimen 2 mm thick, 5 mm wide and 20 mm long, at the conditions of an initial strain of 1%, a dynamic strain frequency of 50 Hz, and a temperature of 60° C.

Moreover, as illustrated in FIG. 1, the side reinforcing rubbers 5 are preferably arranged on the tire widthwise inner side of the carcass 6.

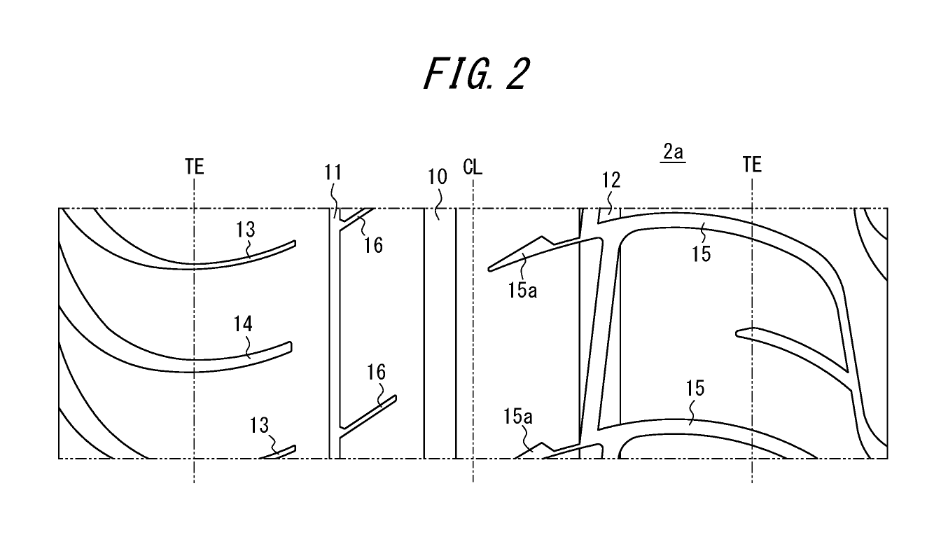

Next, FIG. 2 illustrates a developed view of a tread pattern of a tire according to one embodiment of this disclosure. As illustrated in FIG. 2, the tire of the present embodiment has three circumferential grooves 10, 11, 12 on the tread surface 2a. In the illustrated example, two circumferential grooves 10, 11 are formed on one tire widthwise half portion partitioned by the tire equatorial plain CL, and one circumferential groove 12 is formed on the other tire widthwise half portion. For example, the aforementioned one tire widthwise half portion may be the vehicle-installed inner side. In the present embodiment, the circumferential groove 10, 11, 12 are 2 mm or more. Further, in the embodiment as illustrated in FIG. 2, it is preferable that one tread widthwise half portion partitioned by the tire equatorial plain CL on which the circumferential grooves 10, 11 are located is the vehicle-installed inner side, and the other tread widthwise half portion partitioned by the tire equatorial plain CL on which the circumferential groove 12 is located is the vehicle-installed outer side.

As illustrated in FIG. 2, the tire of this disclosure has on the tread surface 2a a plurality of widthwise grooves 13, 14, 15 extending in the tire width direction. Moreover, a narrow groove 16, which connects to the circumferential groove 11 and ends within the land portion, is formed on the circumferential groove 11. Further, the widthwise groove 15 has a widened width portion 15a, where the groove width is wider than the groove width of the portion connecting to the circumferential groove 12.

In the present embodiment, a negative ratio (a ratio of the groove area to the area of the entire tread surface) is preferably 25% or less. This is because that the steering stability can be improved. For the same reason, the negative ratio is more preferably 15% or less. Further, in this disclosure, OD/RD is preferably 1.4 or less, where RD is a tire inner diameter, i.e., a diameter of a part contacting the rim when the tire is incorporated with the rim. This is because that such tire has a negative ratio of 25% or less (more preferably 15% or less), and thus is capable of achieving both steering stability and high fuel efficiency at a high level. Furthermore, this disclosure may be configured such that a plurality of circumferential grooves are formed, and a circumferential groove on a tire widthwise outer side has a larger groove width. This is because that the drainage performance can be improved. Further, in this disclosure, it is preferable that the groove width of the widthwise grooves is shorter than the groove width of the circumferential grooves, the widthwise grooves are formed on circumferential land portions partitioned by a plurality of circumferential grooves, and the widthwise grooves are formed from the circumferential grooves toward the inner side of the circumferential land portions, and end within end portions within the circumferential land portions. This is because that the driving force and the braking force can be improved. Moreover, in this disclosure, it is preferable that in the circumferential grooves, narrow grooves connecting to the circumferential grooves and ending within the land portions are formed, and the angle of the narrow grooves with respect to the tire width direction is 20° or less. This is because that the side force and the riding comfort can be ensured. Further, in this disclosure, it is preferable that the widthwise grooves formed on the circumferential land portions have widened width portions, where the groove width is larger than the groove width of the portions connecting to the circumferential grooves, and becomes smaller from the widened width portions toward the end portions of the widthwise grooves. This is because that the drainage performance can be improved. Furthermore, in this disclosure, in the state where the tire is installed to a vehicle, it is preferable that the negative ratio (the ratio of the circumferential grooves to the area of the tread surface) of the vehicle-installed side inner than the tire equatorial plain CL is larger than the negative ratio (the ratio of the circumferential grooves to the area of the tread surface) of the vehicle-installed outer side. Alternatively, it is preferable that the negative ratio (the ratio of all the grooves to the area of the tread surface) of the vehicle-installed side inner than the tire equatorial plain CL is smaller than the negative ratio (the ratio of all the grooves to the area of the tread surface) of the vehicle-installed outer side. This is because that the drainage performance can be improved. In addition, in this disclosure, it is preferable that small land portions partitioned by the circumferential grooves and the widthwise grooves are arranged along the tire circumferential direction, and the small land portions have land portion surfaces corresponding to the tread surface contacting the road surface, land portion side surfaces forming groove wall surface of the widthwise grooves, and land portion inclined surfaces continuous to the land portion surfaces and the land portion side surfaces, where the land portion inclined surfaces have curved surfaces inclined from the tire widthwise outer side toward the inner side, to the tire circumferential direction and the tire width direction, and protruding toward a tire central side in the tire radial direction; the height of the land portion side surfaces, which is the height from the groove bottom surface of the widthwise grooves, decreases along with the inclination of the land portion inclined surfaces; connection portions connecting the land portion inclined surfaces and the land portion surfaces have a round shape such that bended portions protruding toward the tire radial outer side are formed, the connection portions having a round shape extending approximately in accordance with the tire circumferential direction, and adjacent connection portions being in accordance with each other in the tire circumferential direction.

In this disclosure, the (total) groove area of the widthwise grooves is preferably larger than the (total) groove area of the circumferential grooves. This is because that the drainage performance can be improved. In this case, OD/RD is preferably 1.4 or less, which achieves both high fuel efficiency and steering stability.

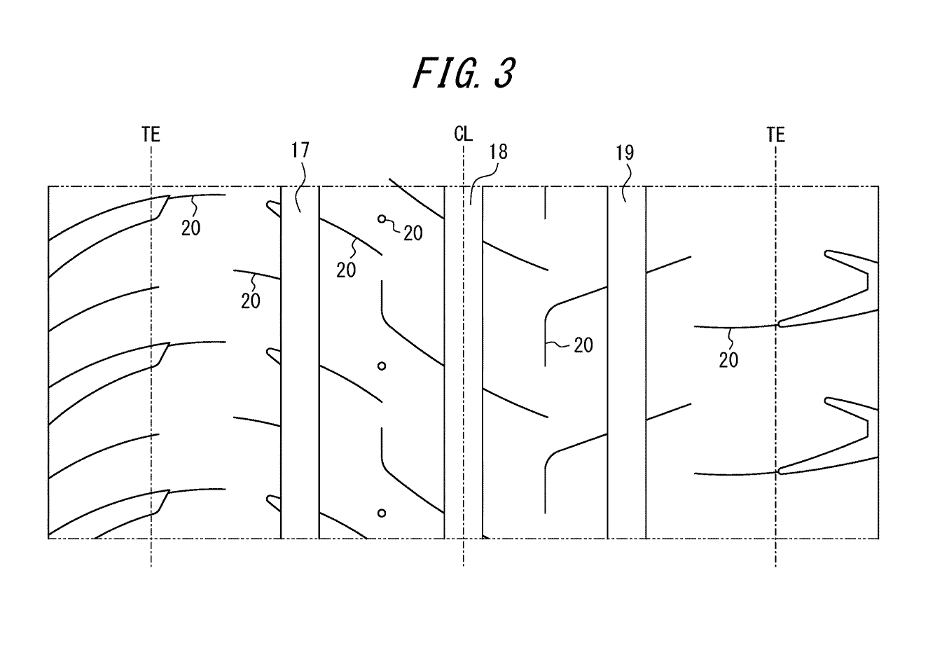

Next, FIG. 3 illustrates a developed view of a tread pattern of a tire according to another embodiment of this disclosure. The tire of the embodiment as illustrated in FIG. 3 has three circumferential grooves 17, 18, 19 on the tread surface 2a. In the illustrated example, one circumferential groove 17 is formed on one tire widthwise half portion partitioned by the tire equatorial plain CL, and two circumferential grooves 18, 19 are formed on the other tire widthwise half portion. Moreover, the tire of the embodiment as illustrated in FIG. 3 has on the tread surface 2a a plurality of supplemental grooves 20 with a groove width of 2 mm or less. For example, the aforementioned one tire widthwise half portion may be the vehicle-installed outer side. In the present embodiment, circumferential grooves 17, 18, 19 are 5 mm or more. Further, in the embodiment as illustrated in FIG. 3, it is preferable that one tread widthwise half portion partitioned by the tire equatorial plain CL on which the circumferential groove 17 is located is the vehicle-installed inner side, and the other tread widthwise half portion partitioned by the tire equatorial plain CL on which the circumferential groove 19 is located is the vehicle-installed outer side.

In the present embodiment, as for the grooves, the tread surface preferably has merely at least one circumferential groove extending in the tire circumferential direction, or has merely a circumferential groove and at least one supplemental groove other than the circumferential groove, the supplemental groove having a groove width of a tread widthwise region of 80% of the tread width of the tread surface centering on the tire equatorial plain is 2 mm or less, where the negative ratio of the circumferential groove is 12% or more and 20% or less. This is because that both the drainage performance and the travelling performance on dry road surface can be achieved. Moreover, in this disclosure, the supplement groove (inclusive of hole-shaped recesses with a diameter of 2 mm or less) preferably has a total extension per unit area of the tread surface of 0.05 (mm/mm²) or less. This is because that the travelling performance on dry road surface can be further ensured. Here, the “total extension” refers to a value obtained by dividing the extending length (the length along the extension direction) of all the supplemental grooves arranged within the tread surface by the area of the tread surface. Further, in this disclosure, it is preferable that the tread surface has at least two circumferential grooves extending in the tire circumferential direction, and has a tire widthwise outermost land portion partitioned by the tread edge and a circumferential groove closest to the tread edge, and at least one tire widthwise inner land portion partitioned by the circumferential grooves on a tire widthwise inner side of the tire widthwise outermost land portion, where the tire widthwise width of the tread widthwise outermost land portion is ⅕ or more of the tread width. This is because that the steering stability can be improved. Furthermore, in this disclosure, the tread widthwise inner land portions preferably has a tire widthwise width of 23 mm or more. This is because that the steering stability can be improved. In addition, it is preferable that in at least one land portion among the tire width direction inner land portions partitioned by the circumferential grooves and a land portion partitioned by the circumferential groove closest to the tread edge and borderlines partitioning on the tread surface a tread widthwise region of 80% of the tread width centering on the tire equatorial plain, the relation expressions ¼≦W1/W2≦¾, and ΣW1≧W2 are satisfied, where W1 (mm) is a tire widthwise projected length of the supplemental groove, W2 (mm) is a tire widthwise width of at least one land portion, and ΣW1 (mm) is a total tread widthwise projected length within one pitch of the supplemental grooves in the tire circumferential direction. This is because that the travelling performance on dry road surface can be further improved.

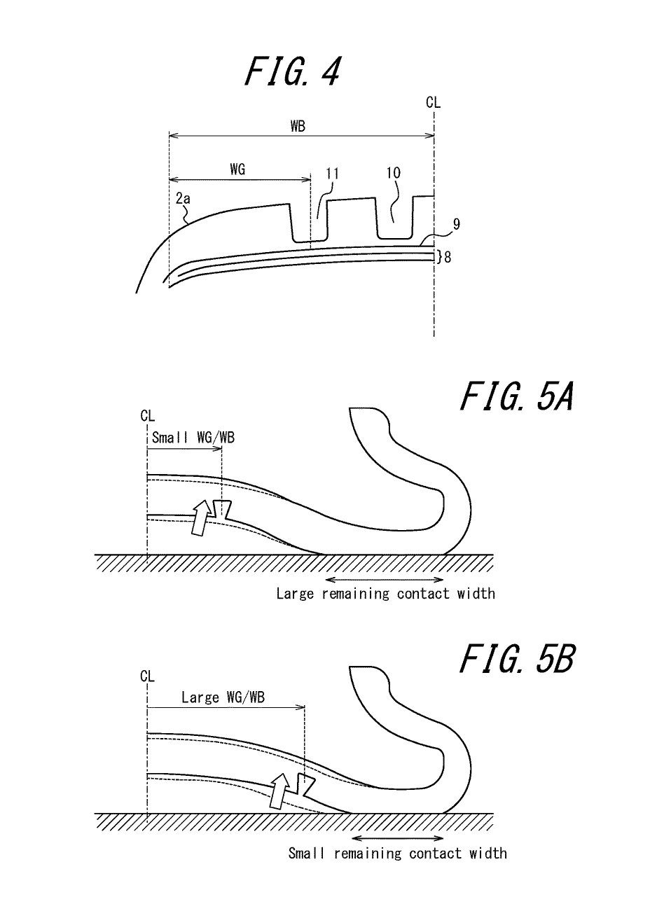

FIG. 4 illustrates a tire widthwise partial cross-sectional view of a run-flat tire according to one embodiment of this disclosure. Illustrated in FIG. 4 is a tire widthwise cross section of the tire in a reference state as being mounted to a rim and filled with a predetermined internal pressure with no load applied thereon.

Further, when WB is a tire widthwise half width of a belt layer with a maximum tire widthwise width among the one or more belt layers, and WG is a tire widthwise distance from a tire widthwise end of the belt layer with a maximum tire widthwise width to a tire widthwise central position of the tire widthwise outermost circumferential groove 11 among the one or more circumferential grooves, the tire of the present embodiment satisfies the relation expression:

0.5≦WG/WB≦0.8

Hereinafter, the effects of the run-flat tire of the present embodiment are described.

We have intensively studied the problem of improving the fuel efficiency and simultaneously ensuring the run-flat durability. As a result, it was discovered that in a narrow-width, large-diameter tire satisfying the aforementioned relation expression regarding the sectional width SW and the outer diameter OD, there is a tendency that buckling occurring in the tread portion is reduced, and deformation from the shoulder portion to the buttress portion is comparatively increased.

Then, in the run-flat tire of the present embodiment, by satisfying 0.5≦WG/WB and arranging the circumferential groove 11 close to the center, as shown in the comparison between FIG. 5(a) and FIG. 5(b), it is possible to avoid concentration of ground contact pressure of the shoulder portion due to buckling deformation during run-flat travelling, and to further ensure the run-flat durability. Moreover, by satisfying WG/WB≦0.8, it is possible to ensure the rigidity of the land portion inner in the tire width direction than the circumferential groove 11, and to ensure the cornering power during ordinary travelling. Moreover, the rolling resistance is reduced as well, and thus the fuel efficiency is improved.

As mentioned above, according to the tire of the present embodiment, it is possible to improve the fuel efficiency and to ensure the run-flat durability.

In the run-flat tire of this disclosure, when H1 (mm) is a tire radial maximum length of the side reinforcing rubbers 5, the relation expression:

10 (mm)≦(SW/OD)×H1≦20 (mm)

is preferably satisfied.

This is because that by setting (SW/OD)×H1 to 10 (mm) or more, it is possible to ensure the volume of the side reinforcing rubbers 5, and to thereby further ensure the run-flat durability, and on the other hand, by setting (SW/OD)×H1 to 20 (mm) or less, it is possible to reduce the weight of the side reinforcing rubbers 5, and to thereby further improve the fuel efficiency.

Here, the run-flat tire of this disclosure preferably satisfies 1.8≦H1/H2≦3.5, where H2 is the length of a line segment connecting a tire radial outermost point of the bead filler and a tire radial outermost point of the bead core 4a in the tire widthwise cross section in the aforementioned reference state.

This is because that by setting the ratio H1/H2 to 1.8 or more, it is possible to further improve the fuel efficiency, and on the other hand, by setting the ratio H1/H2 to 3.5 or less, it is possible to further ensure the run-flat durability.

In the run-flat tire of this disclosure, a maximum thickness of the side reinforcing rubbers 5 measured in a direction perpendicular to the carcass 6 is preferably 6 mm or less. This is because that it is possible to further improve the fuel efficiency.

Further, in the run-flat tire of this disclosure, in the tire widthwise cross section in the aforementioned reference state, the folded-up end 6c of the carcass folded-up portion 6b is preferably located on a tire radial side inner than the tire maximum width position. This is because that the fuel efficiency can be further improved. For the same reason, in the tire widthwise cross section in the aforementioned reference state, a tire radial height of the folded-up end 6c of the carcass folded-up portion 6b from a tire radial innermost position direction of the carcass 6 is preferably 30 mm or less.

In the tire of this disclosure, the tread surface may have widthwise grooves extending in the tire width direction from the tire widthwise central region to the tread edge TE disposed thereon. In this case, it is possible to obtain a configuration without circumferential grooves extending in the tire circumferential direction on the tread surface.

The tire of this disclosure may be configured such that a plurality of lib-like land portions are partitioned by a plurality of circumferential grooves and tread edges TE. Here, the “lib-like land portion” refers to a land portion extending in the tire circumferential direction without being divided by grooves extending in the tire width direction, and the “lib-like land portion” is inclusive of those having widthwise grooves ending within the lib-like land portion and those divided by sipes.

In the aforementioned case, regarding a tire widthwise outermost land portion partitioned by a tire widthwise outermost circumferential groove and a tread edge TE among the plurality of lib-like land portions, for example, from the viewpoint of improving the steering stability, it is preferable to set the width in the tire width direction of the tire widthwise outermost land portion on the vehicle-installed outer side larger than the tire widthwise width of the tire widthwise outermost land portion on the vehicle-installed inner side.

In the tire of this disclosure, porous members for reducing the cavity resonance noise may be arranged on the tire internal surface. Moreover, for the same reason, electrostatic flocking may be performed to the tire internal surface.

In the tire of this disclosure, it is preferable to arrange on the tire internal surface an inner liner for maintaining the internal pressure of the tire, and the inner liner may be formed of a rubber layer mainly containing a butyle rubber, and a film layer mainly containing a resin.

In the tire of this disclosure, sealant members for avoiding air leakage when puncturing may be arranged on the tire internal surface.

The internal pressure of the tire of this disclosure is preferably 250 kPa or more, more preferably 280 kPa or more, and further more preferably 300 kPa or more.

Moreover, the tire of this disclosure preferably has an air volume of 15000 cm³ or more in order to afford probable load when used on public roads.

### Examples

In order to certify the effects of this disclosure, tires according to Examples 1 to 3 and Comparative Examples 1 to 3 were produced experimentally, and subjected to tests for evaluating the fuel efficiency and the run-flat of the tires. The dimensions of each tire are as shown in the following Table 1.

<Fuel Efficiency>

Tests were performed via JC08 mode travelling. The evaluation results are represented by index with the evaluation result of the tire according to Comparative Example 1 as 100, where a larger index shows a better fuel efficiency.

<Run-Flat Durability>

The tires were travelled on a drum testing machine at a speed of 80 km/h with a load equal to 65% of the maximum load according to the L1 (Load Index) applied thereon, and the distance until the tires failed and became untravelable were measured, with 160 km for 2 hours as the finishing condition. The results of index evaluation were as shown in Table 1, with the run-flat durability of the tire of Comparative Example 1 as 100. A larger value shows a better run-flat durability of the tire.

These evaluation results are shown in the following Table 1 together with the dimensions of the tires.

TABLE 1

| | Example | Example | Example | Comparative | Comparative | Comparative |
|---|---|---|---|---|---|---|
| | 1 | 2 | 3 | Example 1 | Example 2 | Example 3 |
| SW | 155 | 155 | 155 | 225 | 155 | 155 |
| OD | 653 | 653 | 653 | 634 | 653 | 653 |
| Ratio | 0.237 | 0.237 | 0.237 | 0.355 | 0.237 | 0.237 |
| SW/OD | | | | | | |
| Ratio | 0.7 | 0.5 | 0.8 | 0.7 | 0.4 | 0.9 |
| WG/WB | | | | | | |
| Fuel | 128 | 131 | 126 | 100 | 134 | 124 |
| efficiency | | | | | | |
| Run-flat | 158 | 151 | 162 | 100 | 140 | 164 |
| durability | | | | | | |

As shown in Table 1, it is understood that as compared to the tires according to Comparative Examples 1 to 3, each tire according to Examples 1 to 3 achieves both the fuel efficiency and the run-flat durability.

### REFERENCE SIGNS LIST

1 run-flat tire
2 tread portion
3 sidewall portion
4 bead portion
4a bead core
5 side reinforcing rubber
6 carcass
6a carcass main body
6b carcass folded-up portion
6c folded-up end
7 bead filler
8 belt
9 belt reinforcement layer
10, 11, 12 circumferential groove
13, 14, 15 widthwise groove
15a widened width portion
16 narrow groove
17, 18, 19 circumferential groove
20 Supplemental groove
CL tire equatorial plain
TE tread edge

1. A run-flat tire comprising a tread portion, a pair of sidewall portions continuous on both sides of the tread portion, bead portions continuous on each sidewall portion, side reinforcing rubbers with crescent-like cross section disposed on the sidewall portions, and a carcass formed of plies of radially arranged cords extending toroidally between the pair of bead portions, wherein:
when the tire is mounted to a rim, and an internal pressure of 250 kPa or more is applied to the tire,
in a case where a sectional width SW of the tire is less than 165 mm, a ratio of the sectional width SW to an outer diameter OD of the tire, SW/OD, is 0.26 or less; and
in a case where the sectional width SW of the tire is 165 mm or more, the sectional width SW and the outer diameter OD of the tire satisfy a relation expression
OD≧2.135×SW+282.3 (mm);
a tire radial outer side of the carcass further includes a belt formed of one or more belt layers;
the tread portion has one or more circumferential grooves continuously extending in a tire circumferential direction; and
a relation expression
0.5≦WG/WB≦0.8,
is satisfied, where WB represents a half width in the tire width direction of a belt layer maximum in width in the tire width direction of the one or more belt layers in a tire widthwise cross section in a reference state where the tire is mounted to a rim and filled with a predetermined internal pressure with no load applied thereon, and WG represents a tire widthwise distance from a tire widthwise end of the belt layer maximum in width in the tire width direction to a tire widthwise center position of a circumferential groove in the tire widthwise outermost side of the one or more circumferential grooves.

2. The run-flat tire according to claim 1, wherein:
when H1 (mm) is a tire radial maximum length of the side reinforcing rubbers in the tire widthwise cross section in the reference state, a relation expression:
10 (mm)≦(SW/OD)×H1≦20 (mm)
is satisfied.

3. The run-flat tire according to claim 1, wherein:
the bead portions have bead cores, the bead cores further have bead fillers on a tire radial outer side, and
a relation expression:
1.8≦H1/H2≦3.5
is satisfied, where H2 is a length of a line segment connecting a tire radial outermost point of the bead filler and a tire radial outermost point of the bead core in the tire widthwise cross section in the reference state.

4. The run-flat tire according to claim 1, wherein:
a maximum thickness of the side reinforcing rubbers measured in a direction perpendicular to the carcass is 6 mm or less.

5. The run-flat tire according to claim 1, wherein:
the bead portions have bead cores,
the carcass has a carcass main body and a carcass folded-up portion, the carcass main body fixed to the pair of bead cores, the carcass folded-up portion extending from the carcass main body and formed by folding up a circumference of the bead cores from a tire widthwise inner side to a tire widthwise outer side, and
a folded-up end of the folded-up portion is located on a tire radial side inner than a tire maximum width position.
